(19) United States
(12) Patent Application Publication
(10) Pub. No.: US 2016/0172885 A1
(43) Pub. Date: Jun. 16, 2016

(54) Charging System

(71) Applicant: James P. Donovan, Toledo, OH (US)

(72) Inventor: James P. Donovan, Toledo, OH (US)

(21) Appl. No.: 14/964,629

(22) Filed: Dec. 10, 2015

Related U.S. Application Data
(60) Provisional application No. 62/124,193, filed on Dec. 11, 2014.

(51) Int. Cl. H02J 7/00

(52) U.S. Cl. CPC H02J 7/0045; H02J 7/0052

(57) ABSTRACT

A charging system for a battery powered device is described. The system has a battery charger with charging terminals for a battery. An adapter is connected to the charging terminals of the battery charger. An inverter is operatively connected to the adapter and to a source of AC power. A charge module is operatively connected to the receptors on the battery powered device. A power cable electrically connects the adapter to the charge module, the power cable providing DC current from the inverter to the charge module to operate the battery powered device using DC current.

### CROSS REFERENCE TO RELATED APPLICATIONS

This application claims the benefit of U.S. provisional patent application Ser. No. 62/124,193 filed on Dec. 11, 2014.

### BACKGROUND OF THE INVENTION

The invention is directed to a charging system that can be utilized with battery powered devices. One of the primary applications for this technology is power tools. Battery-operated power tools frequently run out of power from the battery at the most inopportune times. This causes delays until the battery can be recharged or a new charged battery can be connected to the power tool. In many applications, the user of the power tool needs to have multiple charged batteries available to allow the power tool to be operated without interruption. But even in this scenario, the user of the power tool needs to locate a new charged battery and attach it to the power tool before use of the power tool can continue. If the charged battery is not conveniently located this can result in significant downtime for the use of the power tool. In addition, the battery that has been discharged will need to be placed on a battery charger to renew the energy level in that battery. The deficiencies associated with running out of battery power has limited the applications for battery power tools in many industries.

Accordingly, there is a need in the battery-powered tool industry for a power tool that can be continuously operated without the need for changing to a new battery with a full power supply. There is also a need for a power tool that can be operated from a continuous source of DC current if the battery connected to the power does not have sufficient electrical energy to effectively operate the power tool. There is also a need for a system that will charge the battery connected to the power tool while the power tool is being operated by the continual source of DC current. The charging system should charge the battery associated with the power tool in the same manner as established by the manufacturer of the power tool and supply DC current from a separate source in a manner that is specified by the manufacturer of the power tool.

### SUMMARY OF THE INVENTION

The present invention is directed to a charging system for a battery powered device. The system has a battery layer with charging terminals for a battery. An adapter is connected to the charging terminal of the battery charger. An inverter is operatively connected to the adapter and to a source of AC power. A charge module is operatively connected to the receptors on the battery powered device. A power cable electrically connects the adapter to the charge module, the power cable providing DC current from the inverter to the charge module to operate the battery powered device using DC current.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a side elevational view of the charging system.

FIG. 2 is a schematic view of the charging system.

FIG. 3 is a schematic view of the charging system being used to charge a battery.

FIG. 4 is a schematic view of the charging system showing the ways that power can be distributed.

### DETAILED DESCRIPTION OF THE PREFERRED EMBODIMENT(S)

The invention is directed to a charging system utilized with a battery power tool or other battery powered device. More particularly, the charging system provides DC current to charge the battery associated with the power tool and DC current to operate the power tool while the battery associated with the power tool is being recharged. The charging system allows the power tool to be operated while the battery for the power tool is being recharged. The features of the invention will be more readily understood by referring to the attached drawings in connection with the following description.

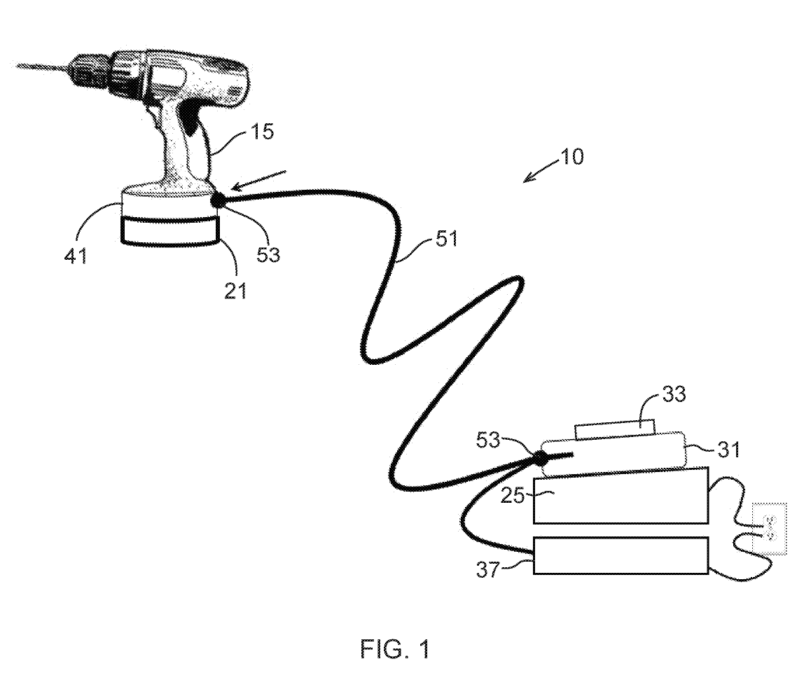

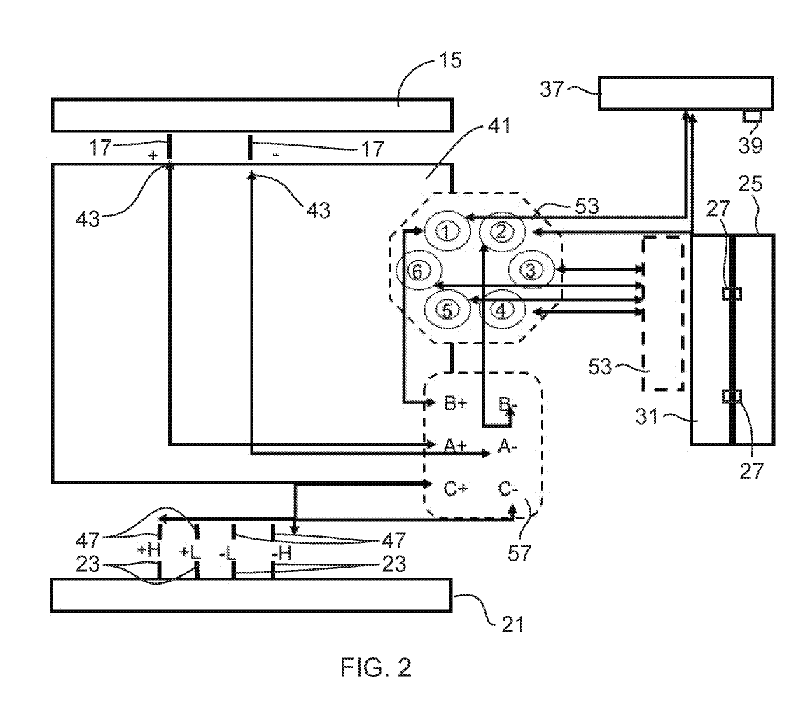

As shown in FIGS. 1-4, the charging system 10 is designed to be utilized with a battery powered tool or other battery powered device. In describing the invention the charging system will be described utilizing a battery power tool. It should be understood, however, that other battery-powered devices can also use the charging system.

The charging system has a power tool 15 and the power tool has receptors 17 that can be operatively connected to a battery 21 for operating the power tool. A battery charger 25 is provided for supplying DC current to charge the battery 21. The battery charger 25 is operatively connected to a source AC power and the battery charger converts the AC power to DC power for charging the battery 21 in a manner well-known in the industry. The battery charger has charge terminals 27 for supplying the DC current that is used to charge the battery 21. An adapter 31 is operatively connected to the charging terminals of the battery charger. The battery charger supplies DC current for charging a battery to the adapter. An inverter 37 is operatively connected to the adapter 31 and to a source of AC power. The inverter 37 converts the AC power to DC power and supplies the DC power to the adapter 31. The DC power from the inverter 37 is supplied to the adapter in a form that can be utilized to operate the tool 15.

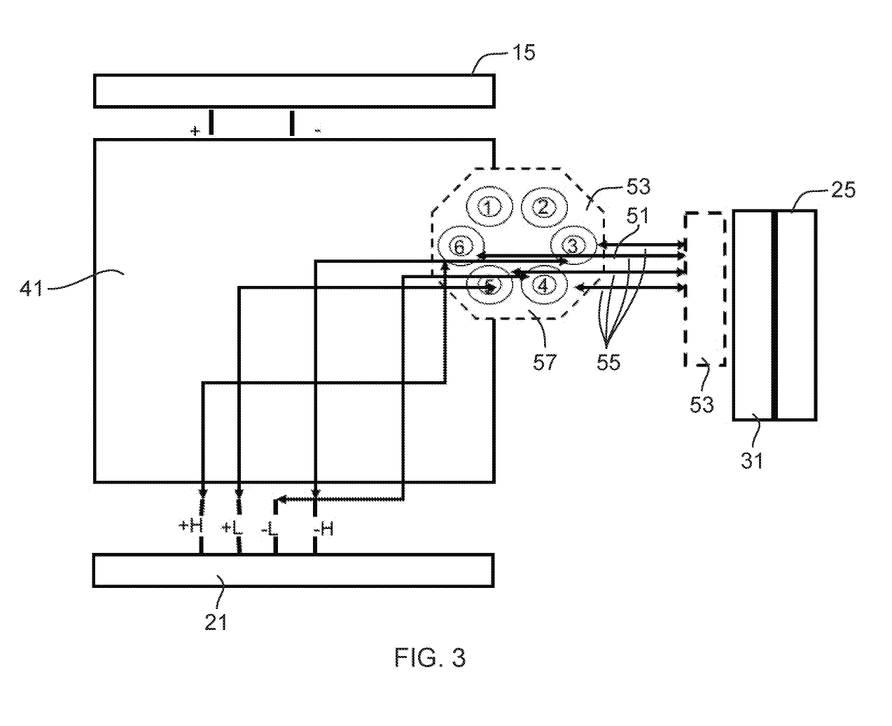

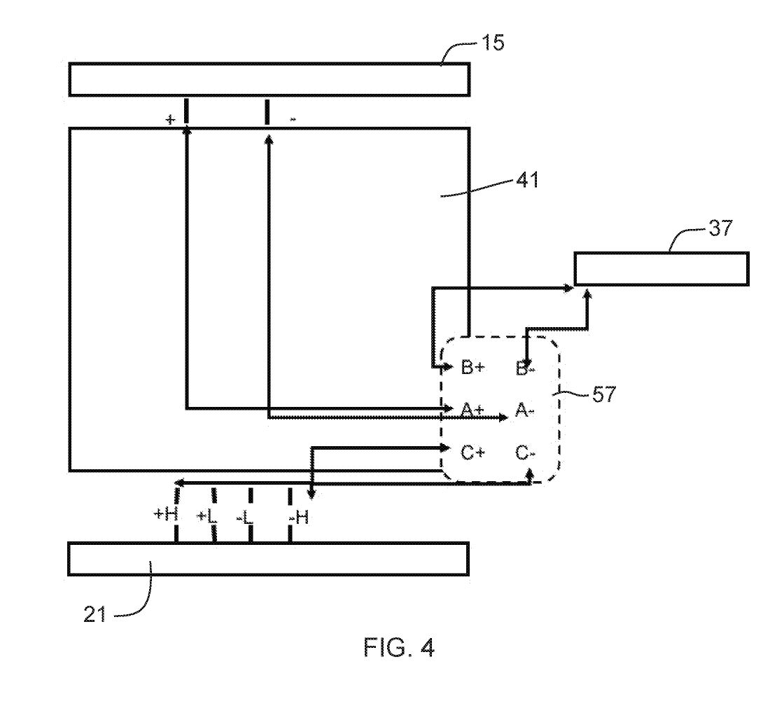

A power module 41 is converted to the power tool 15. The power module has first terminals 43 that are operatively connected to the receptors 17 on the power tool 15. The power module 41 has second terminals 47 that are disposed for being connected to the charging terminals 23 on the battery 21. A power cable 51 extends between the adapter 31 and the power module 41. The power cable has a plurality of wires 55 for conveying the DC current from the battery charger 25 and the DC current from the inverter 37 from the adapter 31 to the power module 41. The number of wires in the power cable is dependent on the number of wires required to operate the power tool 15 and to supply charging power to the battery 21. A connector 53 is provided at each end of the power cable 51 for operatively connecting the power cable to the adapter and the power module. The connector 53 can be designed to provide a quick means for engaging and disengaging the power cable 51 with the adapter 31 and the power module 41. A switch 57 is positioned on the power module for distributing the DC power conveyed through the power cable 51. FIG. 4 shows the connections that can be made by the switch to the tool 15 and the battery 21 to provide power to these components. The switch 57 is designed to provide the DC power from the inverter 37 to the power tool 15 to operate the tool. The switch, as shown in FIG. 3 is designed to provide the DC power from the battery charger 25 to the battery 21 to charge the battery. The switch 57 can be a manual switch that is operated by the user of the power tool 15 or an automatic switch that distributes the DC power to the power tool 15, the battery 21 or to both the power tool and the battery. It should be understood, however, that the power tool only receives DC power from the inverter 37 and the battery 21 only receives DC power from the battery charger 25. As the battery 21 only receives DC power from the battery charger, the battery will be charged in a manner established by the manufacturer of the power tool and the battery. Thus, there is no chance that the battery can be improperly charged or that the warranty for the battery would be violated by this charging system. The charging system 10 allows the power tool to be operated while the battery is simultaneously charged. If the user of the power tool desires to use the battery to power the power tool the power cable 50 can be disconnected from the power module 41.

The adapter can include a plug 33 that is designed to engage the charging terminals 23 on a battery 21. The battery is the same as the battery attached to the power tool 15. The separate battery would be positioned on the adapter 31 and the plug 33 would receive DC current from the battery charger 25 to separately charge the battery positioned on the adapter 31. In this manner, the charging system 10 could be utilized to charge the battery 21 connected to the power module 41 along with the battery 21 connected to the plug 33 on the adapter 31.

The inverter 37 can include a switch 39 to control the voltage output of the inverter. The switch would allow the inverter to work with different power tools or other battery powered devices having different voltage ratings. The limit circuit could also be incorporated into the inverter to reduce the possibility that electrical current, above the design standards of the power tool, are supplied to the power tool. The adapter 31 and the inverter 37 can be incorporated into the battery charger 25 to form a single unit that incorporates all of the functions of these components. The power module 41 can also be incorporated into the power tool 15 or any other battery powered device to form a single unit for these components.

In use, the charging system allows the power tool 15 to be used even if the battery 21 does not have sufficient stored energy to operate the power tool. The power tool is connected to the power cable 51 that extends from the adapter 31. The inverter supplies DC current to the power cable 51 that is sufficient to continuously operate the power tool 15. At the same time the power cable provides sufficient DC current from the battery charger 25 to recharge the battery 21 connected to the power module 41 on the power tool 15. In this manner, the power tool can be operated while the battery for the power tool is being charged. The power cable 51 can be of sufficient length to allow the power tool to be effectively utilized for most applications.

Once the battery 21 has been sufficiently charged, the power cable 51 can be disconnected from the power module 41 on the power tool 15 and the power tool can be utilized using the power from the battery 21. The charging system 10 allows the power tool 15 to be used regardless of whether the battery 21 is sufficiently charged to operate the power tool. The charging system 10 eliminates the need to have multiple charged batteries available to operate battery powered equipment. The charging system also provides the ability to recharge the battery connected to the battery-powered device while the device is still being operated or used.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

I claim:

1. A charging system for a battery powered device having receptors to receive DC current to operate the device comprising:
a battery charger having charging terminals for a battery;
an adapter connected to the charging terminals of the battery charger;
an inverter is operatively connected to the adapter and to a source of AC power;
a charge module is operatively connected to the receptors on the battery powered device;
a power cable electrically connecting the adapter to the charge module, the power cable providing DC current from the inverter to the charge module to operate the battery powered device using DC current.

2. The system of claim 1 wherein the charge module has charging terminals for charging a battery.

3. The system of claim 2 wherein the charging terminals on the charge module and the battery charger are functionally the same.

4. The system of claim 3 wherein a micro switch is positioned on the charge module and operatively connected to a power cable.

5. The system of claim 4 wherein a battery is operatively connected to the charging terminals on the charge module.

6. The system of claim 5 wherein the micro switch can direct DC power from the battery charger to charge the battery connected to charging terminals on the charging module.

7. The system of claim 6 wherein the micro switch can direct DC power to the battery powered device and the battery connected to the charging module whereby the battery powered device can be operated and the battery charged at the same time.

8. The system of claim 7 wherein the adapter has a second set of charging terminals for a battery, the battery charger supplying power to the adapter to charge a battery positioned on the second set of charging terminals of the adapter.
